(19) United States
(12) Patent Application Publication
(10) Pub. No.: US 2011/0014531 A1
(43) Pub. Date: Jan. 20, 2011

(54) FUEL CELL SYSTEM AND FUEL SUPPLY METHOD THEREOF

(75) Inventors: Chih-Yen Lin, Taoyuan County (TW); Chien-Ping Yeh, Taoyuan County (TW); Po-Shao Tung, Taoyuan County (TW); Hsin-Chou Chen, Taoyuan County (TW); Yu-Chun Ko, Taoyuan County (TW); Chiang-Wen Lai, Taoyuan County (TW)

Correspondence Address: QUINTERO LAW OFFICE, PC, 615 Hampton Dr, Suite A202, Venice, CA, 90291, US

(73) Assignee: NAN YA PCB CORP., Taoyuan County (TW)

(21) Appl. No.: 12/574,641

(22) Filed: Oct. 6, 2009

(30) Foreign Application Priority Data
Jul. 20, 2009 (TW) TW098124380

(51) Int. Cl. H01M 8/04; H01M 8/00

(52) U.S. Cl. 429/415; 429/430; 429/454

(57) ABSTRACT

A fuel cell system is provided. The fuel cell system includes a fuel tank, a fuel supply unit, a fuel cell stack, a liquefied recycling unit, a liquid level modulation unit, a sensing unit and a control unit. The fuel supply unit supplies a first fuel to the fuel tank. The fuel tank provides a second fuel to the fuel cell stack, and the fuel cell stack generates a first gas. The liquefied recycling unit liquefies the first gas, transforming the first gas into a recycled fluid. The liquid level modulation unit guides the recycled fluid into the fuel tank to maintain a stable fuel level of the second fuel in the fuel tank. The sensing unit senses a current signal provided by the fuel cell stack. The control unit calculates a current quantity according to the current signal to supply the first fuel to the fuel tank.

### CROSS REFERENCE TO RELATED APPLICATIONS

This Application claims priority of Taiwan Patent Application No. 098124380, filed on Jul. 20, 2009, the entirety of which is incorporated by reference herein.

### BACKGROUND OF THE INVENTION

1. Field of the Invention

The present invention relates to a fuel cell system, and in particular relates to a fuel cell system, wherein fuel therefrom, is precisely supplied.

2. Description of the Related Art

Fuel cells are widely used in domestic backup power systems, transportable power systems, or portable electronic devices. Each fuel cell comprises a Membrane Electrode Assembly (MEA). When fixed concentrations of fuel are provided to an MEA anode and an appropriate amount of oxygen is provided to an MEA cathode, a chemical reaction occurs. Specifically, the chemical reaction is due to the different anode and the cathode potentials, thereby resulting in current which may be provided to an external load. The generated current is environmentally friendly, as organic matter is not produced due to generation by carbon dioxide and water. Conventional fuel cells include direct methanol fuel cells (DMFC) which uses methanol aqueous solutions as fuel for electricity-generation.

However, increasing electricity-generation efficiency of the MEA is hindered by concentration limits for the methanol aqueous solution due to methanol crossover. The concentration limit is determined by the properties of the MEA and is typically not more than 10% (vol %). In addition, operating and environmental temperatures may decrease electricity-generation efficiency of the MEA. Typically, electricity-generation efficiency the MEA decreases when temperatures are high, such as, over 60° C.

DMFC reactions occur according to the following formulas (1) to (3).

Anode reaction: CH₃OH+H₂0→6H⁺+6e⁻+CO₂ (1)

Cathode reaction: 1.5O₂+6H⁺+6e⁻→3H₂O (2)

Overall reaction: CH₃OH+1.5O₂→CO₂+2H₂O (3)

Water is generated during operating of the DMFC, as shown by formula (3). However, the generated water, may be less than the amount of water that is evaporated, due to factors such as operating and environmental temperatures. Moreover, as reaction time increases, the amount of the methanol in the methanol aqueous solution and the concentration of the methanol aqueous solution decrease. Specifically, if the concentration of the methanol aqueous solution is too low, hydrogen protons generated at the anode decreases.

### BRIEF SUMMARY OF THE INVENTION

A detailed description is given in the following embodiments with reference to the accompanying drawings.

A fuel cell system is provided. The fuel cell system includes a fuel tank, a fuel supply unit, a fuel cell stack, a liquefied recycling unit, a liquid level modulation unit, a sensing unit and a control unit. The fuel supply unit is connected to the fuel tank to supply a first fuel to the fuel tank. The fuel cell stack is connected to the fuel tank, wherein the fuel tank provides a second fuel to the fuel cell stack, and the fuel cell stack generates a first gas. The liquefied recycling unit is connected to the fuel cell stack to liquefy the first gas into a recycled fluid. The liquid level modulation unit is connected to the fuel tank and the liquefied recycling unit, wherein the liquid level modulation unit guides the recycled fluid into the fuel tank to maintain a stable fuel level of the second fuel in the fuel tank. The sensing unit is electrically connected to the fuel cell stack, wherein the sensing unit senses a current signal provided by the fuel cell stack. The control unit is electrically connected to the sensing unit and the fuel supply unit, wherein the control unit calculates a current quantity according to the current signal, and when the current quantity reaches a predetermined quantity, the first fuel is supplied to the fuel tank from the fuel supply unit.

The embodiment of the invention uses the liquid level modulation unit and the recycled fluid (for example, water) recycled by the liquefied recycling unit to maintain a stable fuel level of the second fuel (for example, methyl alcohol solution) in the fuel tank. Therefore, when the amount of current reaches a predetermined amount due operating or environmental temperatures, the control unit actuates the fuel supply unit to supply a fixed quantity of the first fuel to the fuel tank, thereby solving the over or under fuel supply problem of conventional methods.

### BRIEF DESCRIPTION OF THE DRAWINGS

The present invention can be more fully understood by reading the subsequent detailed description and examples with references made to the accompanying drawings, wherein:

FIG. 1 shows a fuel cell system of an embodiment of the invention;

FIG. 2 shows a liquefied recycling unit of the embodiment of the invention;

FIGS. 2a and 2b show liquefiers utilized in the embodiment of the invention;

FIG. 3a shows the level of the second fluid in a fuel tank being lower than a free end of an exhaust tube;

FIG. 3b shows the level of the second fluid in the fuel tank reaches the free end of the exhaust tube;

FIG. 4 shows a fuel supply method of the embodiment of the invention.

FIGS. 5a-5e shows a detailed structure of a liquid level modulation unit and a fuel tank of a modified embodiment of the invention; and

FIG. 6 shows another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

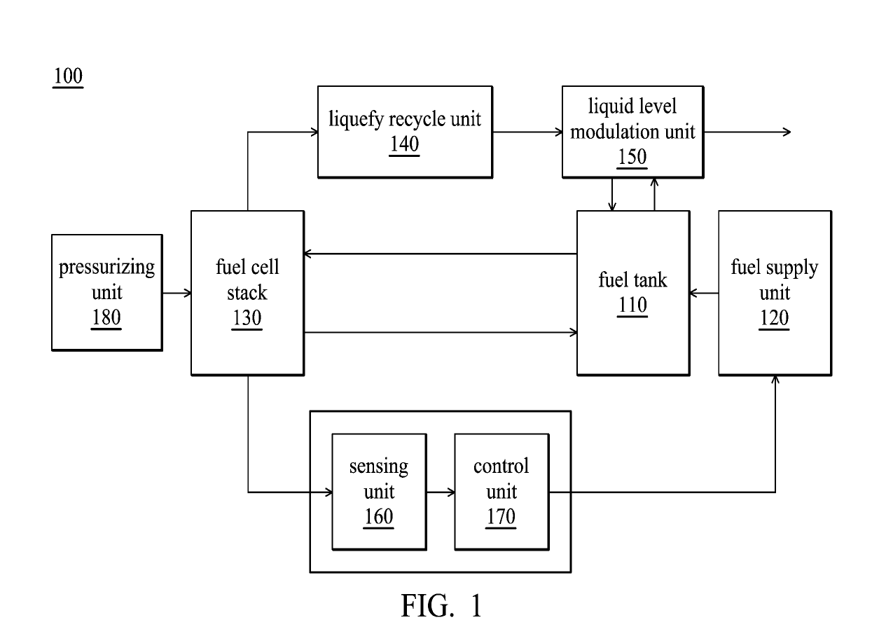

FIG. 1 shows a fuel cell system 100 of an embodiment of the invention, which comprises a fuel tank 110, a fuel supply unit 120, a fuel cell stack 130, a liquefied recycling unit 140, a liquid level modulation unit 150, a sensing unit 160, a control unit 170 and a pressurizing unit 180. The fuel supply unit 120 is connected to the fuel tank 100 to supply a first fuel (for example, methyl alcohol) to the fuel tank 110. The fuel cell stack 130 is connected to the fuel tank 110, wherein the fuel tank 110 provides a second fuel (for example, methyl alcohol solution) to the fuel cell stack 130, and the fuel cell stack 130 generates a first gas (for example, water steam). The liquefied recycling unit 140 is connected to the fuel cell stack 130 to liquefy the first gas into a recycled fluid (for example, water). The liquid level modulation unit 150 is connected to the fuel tank 110 and the liquefied recycling unit 140, wherein the liquid level modulation unit 150 maintains a stable fuel level of the second fuel in the fuel tank 110. The sensing unit 160 is electrically connected to the fuel cell stack 130, wherein the sensing unit 160 senses a current signal provided by the fuel cell stack 130. The control unit 170 is electrically connected to the sensing unit 160 and the fuel supply unit 120, wherein the control unit 170 calculates a current quantity provided by the fuel cell stack 130 according to the current signal. When the current quantity reaches a predetermined quantity, the control unit 170 actuates the fuel supply unit 120 to supply the first fuel to the fuel tank 110. The pressurizing unit 180 provides an operating pressure to the fuel cell system to move the first gas to the liquefied recycling unit 140 to be recycled.

The embodiment of the invention uses the liquid level modulation unit 150 and the recycled fluid (for example, water) recycled by the liquefied recycling unit 140 to maintain a stable fuel level of the second fuel (for example, methyl alcohol solution) in the fuel tank 110. Therefore, when the current quantity reaches a predetermined quantity under a specific temperature and voltage condition, the control unit 170 actuates the fuel supply unit 120 to supply the first fuel of fixed quantity to the fuel tank 110. Thus, over or under supply of the first fuel is avoided.

In the embodiment above, the first fuel and the second fuel can be a methyl alcohol solution. A consistency of the first fuel is over 50% (vol %), for example, 100% (vol %). A consistency of the second fuel is lower than 10% (vol %), for example, 2-4% (vol %). The recycled fluid is water.

In a modified embodiment, the fuel cell system 100 further comprises a metering pump unit. The metering pump unit is electrically connected to the control unit. The control unit actuates the metering pump unit to supply the first fuel from the fuel supply 120 to the fuel tank 110. Additionally, the control unit actuates the metering pump unit to move the second fuel (reacted) from the fuel cell stack 130 to the fuel tank 110.

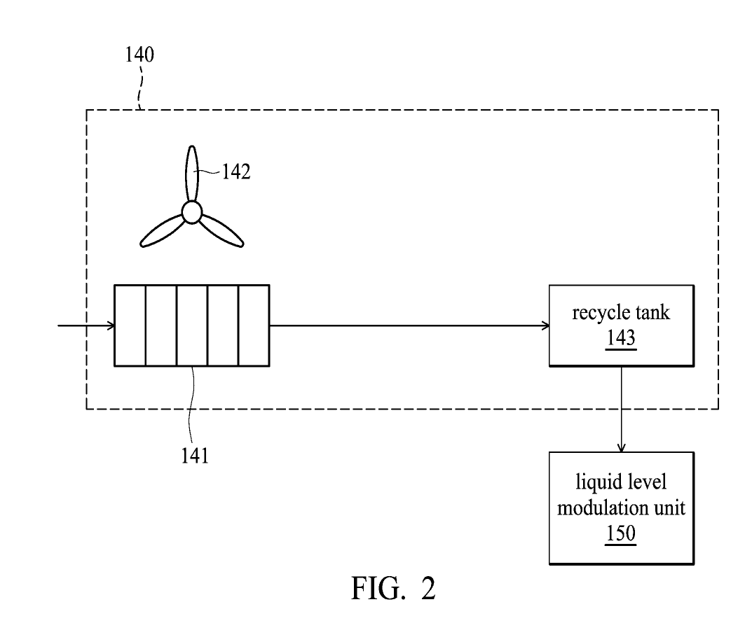

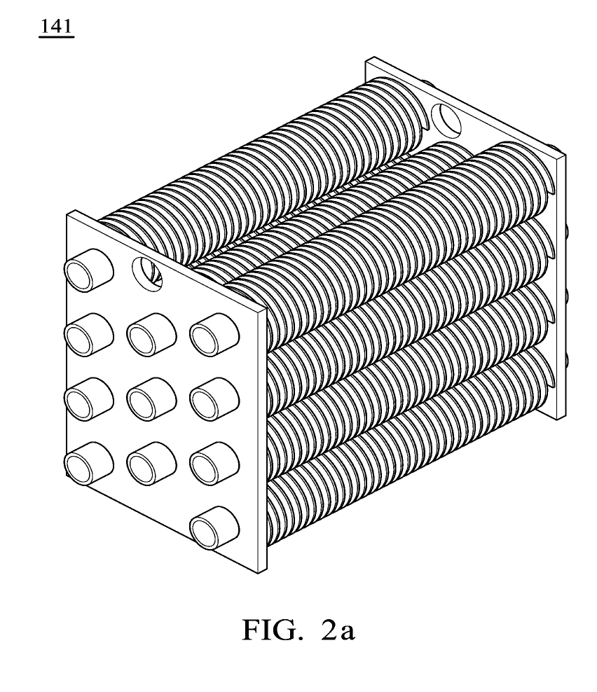

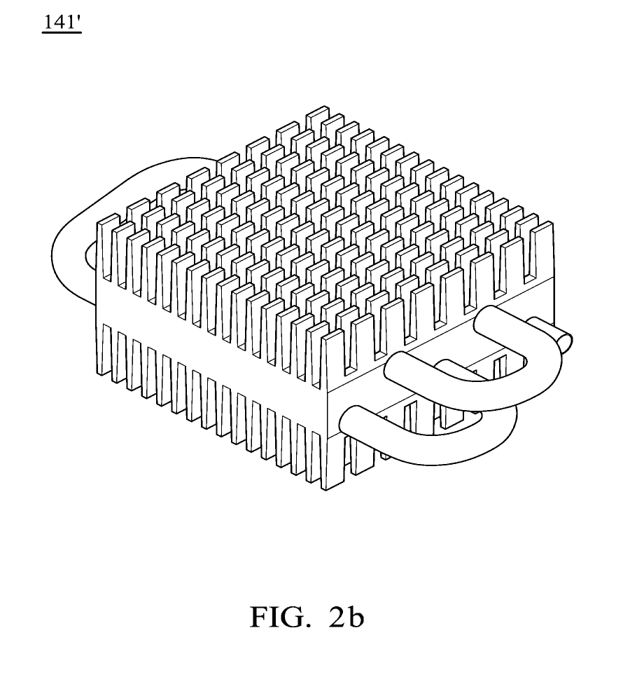

With reference to FIG. 2, the liquefied recycling unit 140 comprises a liquefier 141, a fan 142 and a recycling tank 143. The pressurizing unit 180 (FIG. 1) moves the first gas to the liquefier 141, the fan 142 cools the liquefier 141, the liquefier 141 liquefies the first gas, transforming the first gas into the recycled fluid, and the recycled fluid is moved into the recycling tank 143 to be stored. FIGS. 2a and 2b show liquefier 141 and liquefier 141′ utilized in the embodiment of the invention.

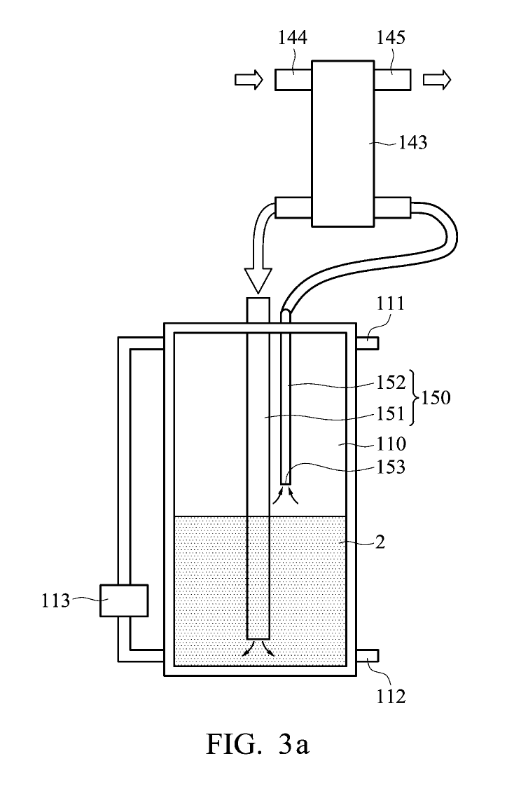

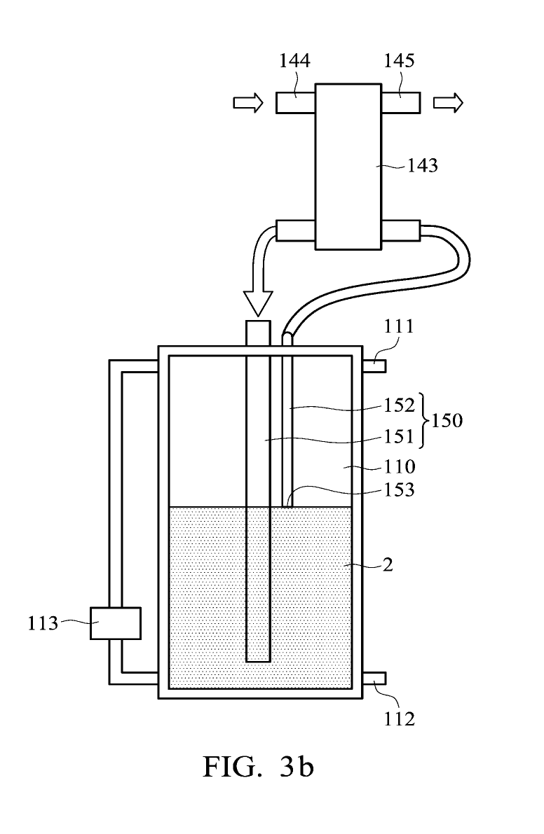

FIGS. 3a and 3b show a detailed structure of the liquid level modulation unit. The liquid level modulation unit 150 is connected to the recycling tank 143 and the fuel tank 110. The liquid level modulation unit 150 comprises a supply tube 151 and an exhaust tube 152. The supply tube 151 and the exhaust tube 152 are connected to a bottom of the recycling tank 143. The supply tube 151 connects the recycling tank 143 to the fuel tank 110. The exhaust tube 152 connects the recycling tank 143 to the fuel tank 110. With reference to FIG. 3a, when the level of the second fluid 2 in the fuel tank 110 is lower than the free end 153 of the exhaust tube 152, the recycled fluid travels from the recycling tank 143, passes through the supply tube 151 to the fuel tank 110, and air (second gas, carbon dioxide) in the fuel tank 110 travels from the fuel tank 110, passes through the exhaust tube 152 to the recycling tank 143. With reference to FIG. 3b, when the level of the second fluid 2 in the fuel tank 110 reaches the free end 153 of the exhaust tube 152, air above the second fluid 2 in the fuel tank 110 is condensed to increase an air pressure therein (in this embodiment, air pressure in the fuel tank is about 0.15 kg/cm²), and the second fluid 2 is pressured and prevented from traveling to the fuel tank 110.

With reference to FIGS. 3a and 3b, the recycling tank 143 comprises a water inlet 144 and an air outlet 145. The water inlet 144 and the air outlet 145 are located on an upper portion of the recycling tank 143. The recycled fluid is moved to enter into the recycling tank 143 via the water inlet 144, and a gas traveling with the recycled fluid is exhausted via the air outlet 145. The second gas from the fuel tank 110 passing through the exhaust tube 152 to the recycling tank 143 is also exhausted via the air outlet 145. The fuel tank 110 has a recycled reaction fluid (second fuel, methyl alcohol solution) inlet 111 and a recycled reaction fluid outlet 112. When the recycled reaction fluid (second fuel, methyl alcohol solution) is over infused from the recycled reaction fluid inlet 111, redundant recycled reaction fluid (second fuel) also travels from the fuel tank 110, passing through the exhaust tube 152, into the recycling tank 143, and is exhausted through the air outlet 145.

The fuel tank 110 further comprises a critical level detector 113 disposed therein. When the level of the second fuel in the fuel tank 110 downs to a critical level, the critical level detector 113 sends a critical signal to the control unit 170, and the control unit 170 stops the fuel cell system according to the critical signal.

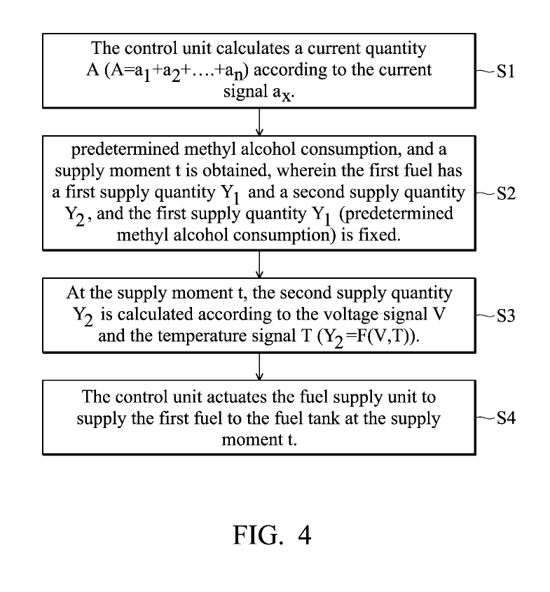

In the embodiment of the invention, the sensing unit 160 senses a voltage signal provided by the fuel cell stack 130 and a temperature signal of the fuel cell stack 130. The control unit 170 actuates the fuel tank to supply the first fuel according to the voltage signal and the temperature signal. FIG. 4 shows a fuel supply method of the embodiment of the invention. First, the control unit calculates a current quantity A (A=a₁+a₂+ . . . +aₙ) according to the current signal aₓ (S1). Then, when the current quantity A reaches a predetermined quantity Aₛₜ, a predetermined methyl alcohol consumption is reached, and a supply moment t is obtained (S2). Specifically, the first fuel has a first supply quantity Y₁ and a second supply quantity Y₂, and the first supply quantity Y₁ (predetermined methyl alcohol consumption) is fixed. Next, at the supply moment t, the second supply quantity Y₂ is calculated according to the voltage signal V and the temperature signal T (Y₂=F(V,T)) (S3). Finally, the control unit actuates the fuel supply unit to supply the first fuel to the fuel tank at the supply moment t (S4).

When the reaction of the fuel cell stack 130 is stable, the voltage signal V and the temperature signal T are stable, and the second supply quantity Y₂ is a fixed value (for example, zero). Therefore, the first fuel can be supplied with fixed quantity.

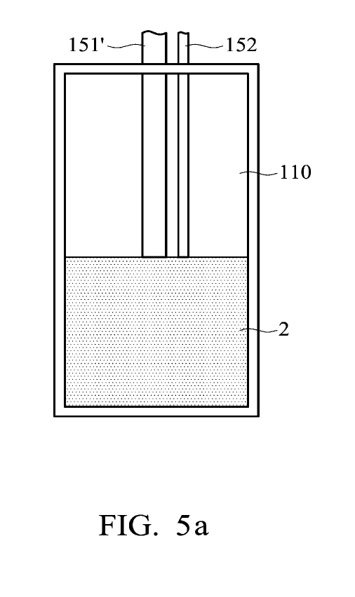

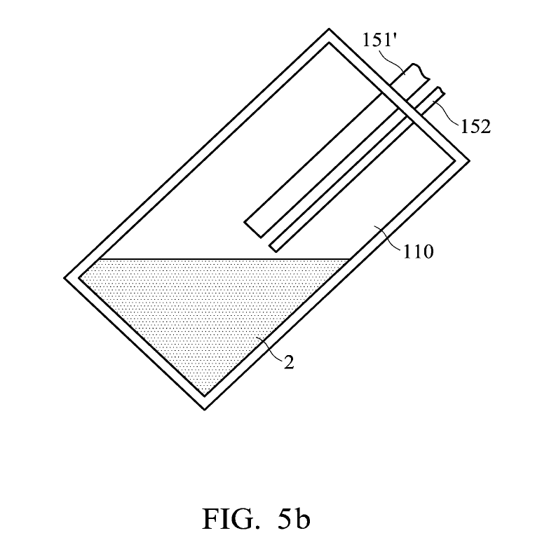

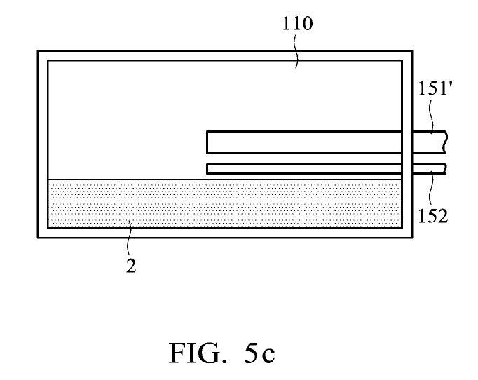

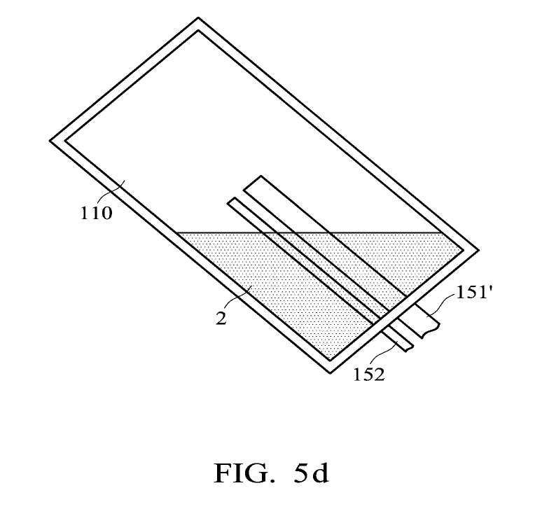

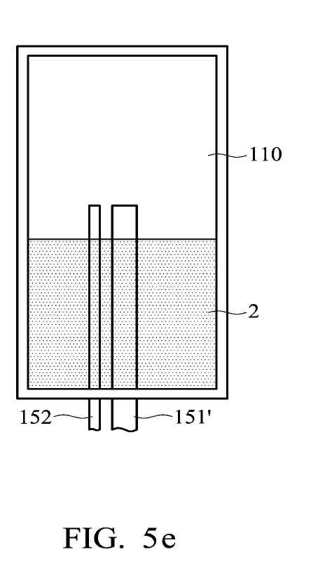

With reference the FIGS. 5a˜5e, in one embodiment, free ends of the supply tube 151′ and the exhaust tube 152 are located in the center of the fuel tank 110. The level of the second fuel 2 is substantially located in the center of the fuel tank 110. Therefore, during the fuel tank is transmitted, the second fuel 2 will not leak due to inclined positioning.

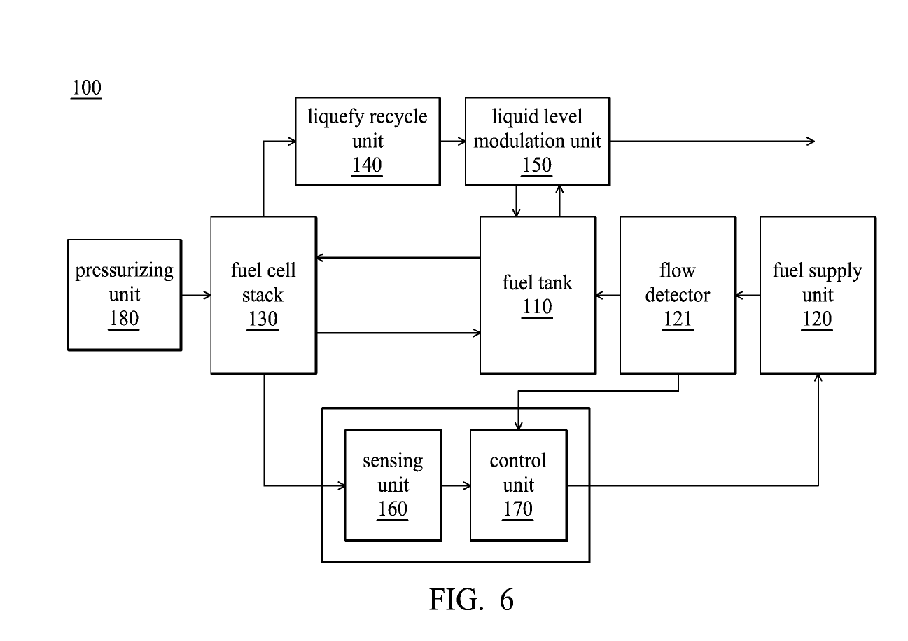

With reference to FIG. 6, in one embodiment, a flow detector 121 is disposed between the fuel supply unit 120 and the fuel tank 110 to ensure the first fuel is supplied to the fuel tank 110 from the fuel supply unit 120 and to avoid a situation, wherein insufficient first fuel supply may damage the fuel cell stack 130. When the first fuel in the fuel supply unit 120 is exhausted, the flow detector 121 sets of an alarm, and stops the fuel cell system, and shows that the first fuel is exhausted. Thereafter, a user can restart the fuel cell system after resupplying or replacing the fuel supply unit 120.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fuel cell system, comprising:
a fuel tank;
a fuel supply unit, connected to the fuel tank to supply a first fuel to the fuel tank;
a fuel cell stack, connected to the fuel tank, wherein the fuel tank provides a second fuel to the fuel cell stack, and the fuel cell stack generates a first gas;
a liquefied recycling unit, connected to the fuel cell stack to liquefy the first gas into a recycled fluid;
a liquid level modulation unit, connected to the fuel tank and the liquefied recycling unit, wherein the liquid level modulation unit guides the recycled fluid into the fuel tank to maintain a stable fuel level of the second fuel in the fuel tank;
a sensing unit, electrically connected to the fuel cell stack, wherein the sensing unit senses a current signal provided by the fuel cell stack; and
a control unit, electrically connected to the sensing unit and the fuel supply unit, wherein the control unit calculates a current quantity according to the current signal, and when the current quantity reaches a predetermined quantity, the first fuel is supplied to the fuel tank from the fuel supply unit.

2. The fuel cell system as claimed in claim 1, wherein a consistency of the first fuel is over 50% (vol %), and a consistency of the second fuel is lower than 10% (vol %).

3. The fuel cell system as claimed in claim 1, wherein the first fuel is methyl alcohol, and the second fuel is methyl alcohol solution.

4. The fuel cell system as claimed in claim 1, further comprising a pressurizing unit, wherein the pressurizing unit provides an operating pressure to the fuel cell system to move the first gas to the liquefied recycling unit to be recycled as the recycled fluid.

5. The fuel cell system as claimed in claim 4, wherein the liquefied recycling unit comprises a liquefier, a fan and a recycling tank, the pressurizing unit moves the first gas to the liquefier, the fan cools the liquefier, the liquefier liquefies the first gas into the recycled fluid, and the recycled fluid is moved to the recycling tank to be stored.

6. The fuel cell system as claimed in claim 5, wherein the liquid level modulation unit is connected to the recycling tank and the fuel tank, and when the level of the second fluid in the fuel tank downs, the liquid level modulation unit moves the recycled fluid from the recycling tank to the fuel tank.

7. The fuel cell system as claimed in claim 6, wherein the liquid level modulation unit comprises a supply tube and an exhaust tube, the supply tube connects the recycling tank to the fuel tank, the exhaust tube connects the recycling tank to the fuel tank, and when the level of the second fluid in the fuel tank is lower than the free end of the exhaust tube, the recycled fluid travels from the recycling tank, passing through the supply tube to the fuel tank.

8. The fuel cell system as claimed in claim 7, wherein when the level of the second fluid in the fuel tank reaches the free end of the exhaust tube, the recycled fluid is prevented from traveling to the fuel tank.

9. The fuel cell system as claimed in claim 8, wherein when the level of the second fluid in the fuel tank reaches the free end of the exhaust tube, an air pressure in the fuel tank is about 0.15 kg/cm².

10. The fuel cell system as claimed in claim 7, wherein the recycling tank comprises an air outlet, and a second gas travels from the fuel tank, passes through the exhaust tube and the recycling tank, and leaves the recycling tank through the air outlet.

11. The fuel cell system as claimed in claim 10, wherein the second gas is carbon dioxide.

12. The fuel cell system as claimed in claim 1, wherein the sensing unit senses a voltage signal provided by the fuel cell stack and a temperature signal of the fuel cell stack, and the control unit supplies the first fuel to the fuel tank according to the voltage signal and the temperature signal.

13. The fuel cell system as claimed in claim 1, further comprising a critical level detector, wherein the critical level detector is disposed in the fuel tank, and when the level of the second fuel in the fuel tank reaches a critical level, the critical level detector sends a critical signal to the control unit, and the control unit stops the fuel cell system according to the critical signal.

14. A fuel supply method, comprising:
providing the fuel cell system as claimed in claim 1;
sensing a voltage signal provided by the fuel cell stack and a temperature signal of the fuel cell stack; and
the control unit actuating the fuel supply unit to supply the first fuel to the fuel tank when the current quantity reaches the predetermined quantity, wherein the first fuel has a first supply quantity and a second supply quantity, the first supply quantity is fixed, and the control unit calculates the second supply quantity according to the voltage signal and the temperature signal.

15. The fuel supply method as claimed in claim 14, wherein a consistency of the first fuel is over 50% (vol %), and a consistency of the second fuel is lower than 10% (vol %).

16. The fuel supply method as claimed in claim 14, wherein the first fuel is methyl alcohol, and the second fuel is methyl alcohol solution.

17. The fuel supply method as claimed in claim 14, further comprising: providing a pressurizing unit, wherein the pressurizing unit provides an operating pressure to the fuel cell system to move the first gas to the liquefied recycling unit to be recycled as the recycled fluid.

18. The fuel supply method as claimed in claim 14, wherein the liquefied recycling unit comprises a liquefier, a fan and a recycling tank, the pressurizing unit moves the first gas to the liquefier, the fan cools the liquefier, the liquefier liquefies the first gas into the recycled fluid, and the recycled fluid is moved to the recycling tank to be stored.

19. The fuel supply method as claimed in claim 18, wherein the liquid level modulation unit is connected to the recycling tank and the fuel tank, and when the level of the second fluid in the fuel tank downs, the liquid level modulation unit moves the recycled fluid from the recycling tank to the fuel tank.

20. The fuel supply method as claimed in claim 19, wherein the liquid level modulation unit comprises a supply tube and an exhaust tube, the supply tube connects the recycling tank to the fuel tank, the exhaust tube connects the recycling tank to the fuel tank, and when the level of the second fluid in the fuel tank is lower than the free end of the exhaust tube, the recycled fluid travels from the recycling tank, and passes through the supply tube to the fuel tank.

21. The fuel supply method as claimed in claim 20, wherein when the level of the second fluid in the fuel tank reaches the free end of the exhaust tube, the recycled fluid is prevented from traveling to the fuel tank.

22. The fuel supply method as claimed in claim 21, wherein when the level of the second fluid in the fuel tank reaches the free end of the exhaust tube, an air pressure in the fuel tank is about 0.15 kg/cm².

23. The fuel supply method as claimed in claim 20, wherein the recycling tank comprises an air outlet, and a second gas travels from the fuel tank, passes through the exhaust tube and the recycling tank, and leaves the recycling tank through the air outlet.

24. The fuel supply method as claimed in claim 23, wherein the second gas is carbon dioxide.

25. The fuel supply method as claimed in claim 14, further comprising: providing a critical level detector, wherein the critical level detector is disposed in the fuel tank, and when the level of the second fuel in the fuel tank reaches a critical level, the critical level detector sends a critical signal to the control unit, and the control unit stops the fuel cell system according to the critical signal.
